(19) United States
(12) Patent Application Publication
(10) Pub. No.: US 2019/0277320 A1
(43) Pub. Date: Sep. 12, 2019

(54) SELF PIERCING RIVET WITH DUAL ATTACHMENT

(71) Applicant: GM GLOBAL TECHNOLOGY OPERATIONS LLC, DETROIT, MI (US)

(72) Inventors: Steven Cipriano, Chesterfield Township, MI (US); Bradley J. Blaski, Sterling Heights, MI (US); Richard C. Janis, Grosse Pointe Woods, MI (US); Pei-chung Wang, Troy, MI (US)

(21) Appl. No.: 15/918,346

(22) Filed: Mar. 12, 2018

(51) Int. Cl. F16B 5/04; B21J 15/02

(52) U.S. Cl. CPC F16B 5/04; B21J 15/025

(57) ABSTRACT

A method of joining top and bottom layers of material according to the principles of the present disclosure includes providing a rivet having a head and a headless end, wherein a rimmed edge extends downward from the head toward the headless end, applying a layer of adhesive between the top and bottom layers and allowing the adhesive layer to at least partially cure. The method further includes piercing the top layer with a headless end of a rivet after the adhesive layer is cured, deforming the top layer with the rimmed edge and bottom layer with the headless end of the rivet, and forcing the rimmed edge and the headless end of the rivet to bend radially outward during deformation of the top and bottom layers.

### FIELD

The present disclosure relates to methods of joining polymeric composites and other materials using self-piercing rivets.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Carbon fiber reinforced thermoplastics (CFRTP) such as carbon fiber reinforced nylon composites have a high strength-to-weight ratio, which makes these materials desirable for use in automotive applications. For example, to reduce vehicle weight, these materials have been used in parts such as air intake manifolds, air filter housings, resonators, timing gears, radiator fans, and radiator tanks. Despite these advantages, the number of applications for CRFTP materials is limited due to the current processes available for joining CRFTP materials. Therefore, a need exists for improved processes for joining CRFTP materials.

### SUMMARY

A first example method of joining at least two layers of materials including top and bottom layers of material according to aspects of an exemplary embodiment. The method includes providing a rivet having a head and a headless end, wherein a rimmed edge extends downward from the head toward the headless end. Another aspect includes piercing through the top layer with the headless end of the rivet. And still another aspect includes deforming the top layer with the rimmed edge and the bottom layer with the headless end of the rivet. And yet another aspect includes forcing the rimmed edge and the headless end of the rivet to bend radially outward during deformation of the top and bottom layers to form mechanical interlocks with the top and bottom layers. It is appreciated that the method according to the exemplary embodiment may be used with multiple layers, e.g., 3, 4, 5 or more layers, without exceeding the scope of the invention.

A further aspect as according to the exemplary embodiment wherein the rivet is a self-piercing rivet. And a further aspect includes piercing the bottom layer with the headless end of the rivet. Still another aspect includes applying a layer of adhesive between the top and bottom layers. And another aspect includes allowing the adhesive layer to at least partially cure. Yet another aspect includes piercing through the top layer after the adhesive layer is at least partially cured.

Still further aspects according to the exemplary embodiment include positioning the top and bottom layers on a die after applying the adhesive layer between the top and bottom layers and before piercing the top layer with the headless end of a rivet, and bending the rimmed edge radially outward due to force induced during the riveting process, and bending the headless end of the rivet radially outward using a protrusion formed on a bottom surface of the die. And further aspects include clamping the top and bottom layers between a tube and the die; holding the rivet using a piston disposed within the tube; and moving the piston toward the bottom surface of the die to force the headless end of the rivet through the top layer and at least partially into the bottom layer. And still another aspect wherein the top and bottom layers each include a polymeric composite. And yet one other aspect wherein one of the top and bottom layers includes a polymeric composite and the other one of the top and bottom layers includes a metal.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIGS. 1A, 1B, 1C, and 1D are schematic section views of an example self-piercing riveting system for joining at least two layers of material without adhesive according to aspects of an exemplary embodiment;

FIGS. 2A, 2B, and 2C are schematic section views of an example self-piercing riveting system for joining at least two layers of material with according to aspects of the exemplary embodiment;

FIG. 3 is an actual section view of an example riveted joint without adhesive according to aspects of the exemplary embodiment;

FIG. 4 is an actual section view of an example riveted joint with adhesive according to aspects of the exemplary embodiment, where a self-piercing rivet is inserted into two layers of material after the adhesive is allowed to cure;

FIG. 5 is an actual section view of an example riveted joint with adhesive according to aspects of the exemplary embodiment, where a self-piercing rivet is inserted into two layers of material before the adhesive is allowed to cure; and

FIG. 6 is a flowchart illustrating an example method of joining at least two layers of material together using a self-piercing rivet according to aspects of the exemplary embodiment.

In the drawings, reference numbers may be reused to identify similar and/or identical elements.

### DETAILED DESCRIPTION

One process for joining CRFTP and other materials is referred to as self-piercing riveting. In this process, a self-piercing rivet is inserted into at least two layers of material (or workpieces) to join the layers together. The rivet includes a head and a headless end or tail designed to pierce through material. It is appreciated that the method may be used joining various types of materials including, but not limited to, polymeric composite to polymeric composite materials, polymeric composites to metal materials, and metal to metal materials, without exceeding the scope of the disclosure. When the rivet is inserted downward into the layers, the tail pierces through the top layer and then deforms the bottom layer without piercing through the bottom layer. As the tail deforms the bottom layer, the head is seated and deforms in the top layer. The force induced during the riveting process causes a rimmed edge around the head of the rivet to bend radially outward to form an interlock with the top layer, and a die bends the tail radially outward so that the layers are clamped between the head and the tail. In accordance with an exemplary embodiment, this process provides a bottom mechanical interlock so that we have a dual attachment from a single piercing riveting process.

There are several parameters related to the design of the rivet and the die that influence whether the the rivet pierces the top and bottom layers and whether the rimmed edge of the head and the tail are bent upward to create a mechanical interlock after piercing through the workpieces. In addition, the gage (or thickness) of the workpieces and the order in which the workpieces are stacked onto one another affects the behavior of the rivet during the joining operation. Therefore, exhaustive trial-and-error testing may be required to find the optimum process parameters, such as rivet and die designs, which yield maximum joint strength.

In one example, the designs of a rivet and a die may be optimized to yield maximum joint strength when the rivet is used to join a 3-millimeter (mm) layer of CRFTP material is stacked on top of a 2-mm layer of CRFTP material. However, if the 2-mm layer is stacked on top of the 3-mm layer, the rivet and die may have to be redesigned to yield maximum joint strength. Thus, the rivet and die may have to be redesigned each time that the stacking order of the layers changes.

As indicated above, in conventional self-piercing riveting processes, when the rivet is inserted downward into two layers of CRFTP material, the tail pierces through the top layer and then deforms the bottom layer without piercing through the bottom layer.

In contrast, as discussed above, in a self-piercing riveting process according to the present disclosure, when the rivet is inserted downward into two layers of CRFTP material, a rimmed edge surrounding the head pierces into the top layer of material and the tail pierces the bottom layer. In addition, the rimmed edge and the tail are bent radially outward and upward to form mechanical interlocks between the rivet and the workpieces.

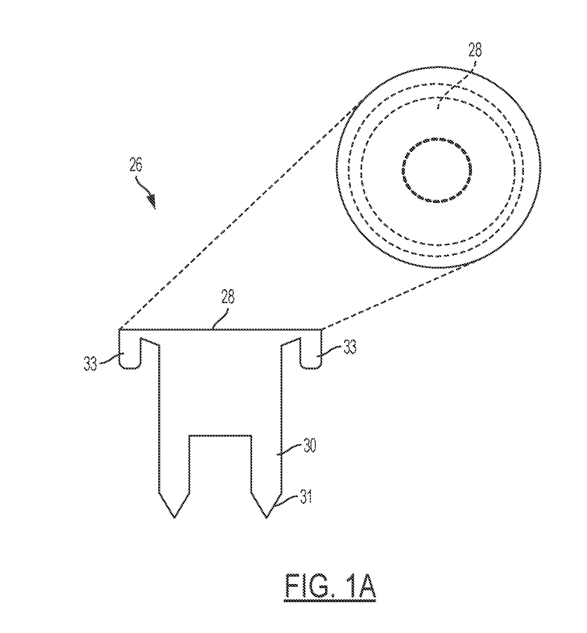

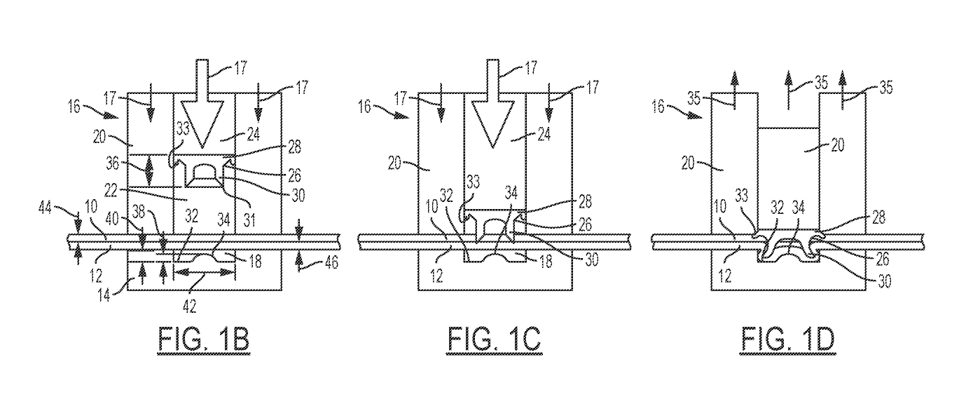

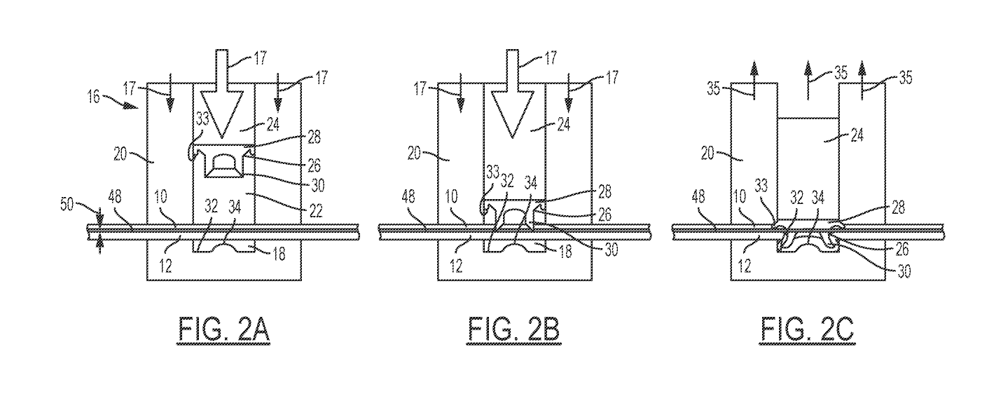

Referring now to FIGS. 1A, 1B, 1C, and 1D, an example self-piercing riveting process for joining at least two layers of material without adhesive is illustrated. In this process, a top layer 10 of material and a bottom layer 12 of material are positioned on a die 14 that is disposed below a rivet insertion tool 16. The top and bottom layers 10 and 12 may be relatively flat sheets, and the die 14 may be cylindrical with a hollow interior or cavity 18. The rivet insertion tool 16 includes a tube 20 with a hollow interior 22 and a piston 24 that is moveable within the hollow interior 22 of the tube 20. The piston 24 holds a self-piercing rivet 26 having a head 28 wherein a rimmed edge 33 extends downward from the head toward a headless end or tail 30 as shown in FIG. 1A. The tail 30 is configured to pierce through material. For example, the tail 30 has a distal end 31 that is sharp. Alternatively, the distal end 31 of the tail 30 may be blunt. Likewise, a distal end of the rimmed edge 33 may be sharp or blunt.

Once the top and bottom layers 10 and 12 are positioned on the die 14, the rivet insertion tool 16 is moved in a downward direction 17 until the tube 20 of the rivet insertion tool 16 contacts the top layer 10 as shown in FIG. 1B. In this position, the top and bottom layers 10 and 12 are clamped between the tube 20 of the rivet insertion tool 16 and the die 14. The piston 24 of the rivet insertion tool 16 is then actuated to move the rivet 26 in the downward direction 17 toward a bottom surface 32 of the die 14.

As the piston 24 moves the rivet 26 in the downward direction 17, the tail 30 of the rivet 26 pierces the top layer 10 as shown in FIG. 1C. As the piston 24 continues to move the rivet 26 in the downward direction 17, the rimmed edge 33 pierces and deforms the top layer 10 and the tail 30 of the rivet 26 pierces and deforms the bottom layer 12 as shown in FIG. 1D. As the rimed edge 33 pierces and deforms the top layer 10, the force induced during the insertion process bends the rimmed edge 33 radially outward and in an upward direction resulting in a mechanical interlock within the top layer 10. Likewise, as the tail 30 deforms the bottom layer 12, a hemispherical protrusion 34 formed on the bottom surface 32 of the die 14 bends the tail 30 radially outward and in an upward direction 35 toward the top layer 10. The piston 24 may be moved in the downward direction 17 until the piston 24 has moved by at least a predetermined distance and/or until the force applied by the piston 24 on the rivet 26 is greater than or equal to a predetermined force.

When the piston 24 stops moving in the downward direction 17, the head 28 of the rivet 26 is fully seated in the top layer 10 with the rimmed edge 33 bent radially outward and upward, and the tail 30 is bent radially outward and upward so as to form mechanical interlocks with the top and bottom layers of material, respectively. As a result, the top and bottom layers 10 and 12 are clamped between the head 28 of the rivet 26 and the tail 30 of the rivet 26 such that the top and bottom layers 10 and 12 are joined together by the rivet 26. The rivet insertion tool 16 is then moved in the upward direction 35, leaving the rivet 26 in place in the top and bottom layers 10 and 12. The downward and upward directions 17 and 35 may be referred to as axial directions, and the radially outward direction in which the tail 30 is bent is partially perpendicular to these axial directions.

The tail 30 may be inserted only partially into the bottom layer 12, or the tail 30 may be inserted completely through the bottom layer 12. In addition, the tail 30 may be bent upward toward the top layer 10 by varying degrees. For example, the tail 30 may be bent only slightly upward as shown in FIG. 1D, or the tail 30 may be bent upward by a greater degree so that the distal end of the tail 30 points toward the top layer 10.

Several parameters related to the design of the rivet 26 and the die 14 may be optimized to ensure that the rimmed edge 33 bends radially outward and upward into the top layer of material 10, and tail 30 pierces the bottom layer 12 and the tail 30 is bent upward toward the top layer 10 after piercing the top and bottom layers 10 and 12. These design parameters may include a length 36 of the rivet 26, a height 38 of the protrusion 34, other geometric aspects of the protrusion 34, a depth 40 of the cavity 18 in the die 14, a diameter 42 of the cavity 18, a volume of the cavity 18, and/or a relationship between two or more of the aforementioned parameters. In addition, one or more of these design parameters may be determined based on a top thickness 44 of the top layer 10, a bottom thickness 46 of the bottom layer 12, the type(s) of material included in the top and bottom layers 10 and 12, and/or the strength of the material(s) included in the top and bottom layers 10 and 12.

In one example, the length 36 of the rivet 26 may be at least 40 percent greater than a sum of the top and bottom thicknesses 44 and 46. Thus, if the top and bottom thicknesses 44 and 46 are each 2.5 mm, the length 36 of the rivet 26 may be at least 7 mm. In other examples, the height 38 of the protrusion 34 may be in a range from 0 mm to 2 mm, and the depth 40 of the cavity 18 may be in a range from 0.5 mm to 2 mm.

In FIGS. 1B, 1C, and 1D the portion of the bottom surface 32 of the die 14 surrounding the protrusion 34 is flat. However, in various implementations, the bottom surface 32 of the die 14 may define an annular trough that extends completely around the protrusion 34 and has a U-shaped cross section. The trough may engage the bottom layer 12 and/or the tail 30 to bend the tail 30 in the upward direction 35.

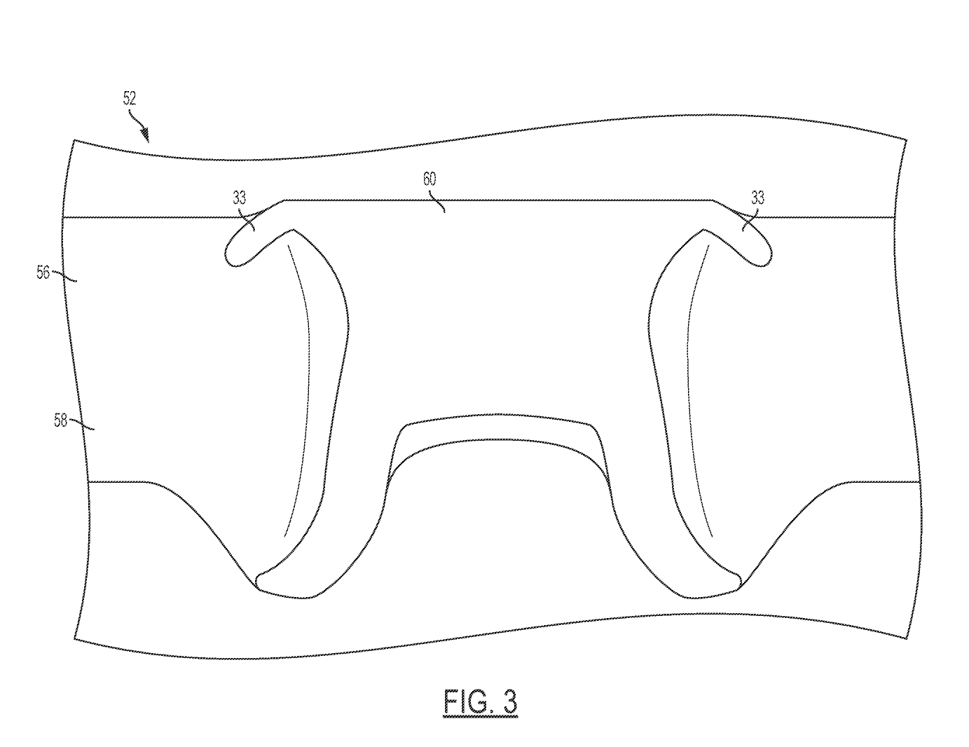

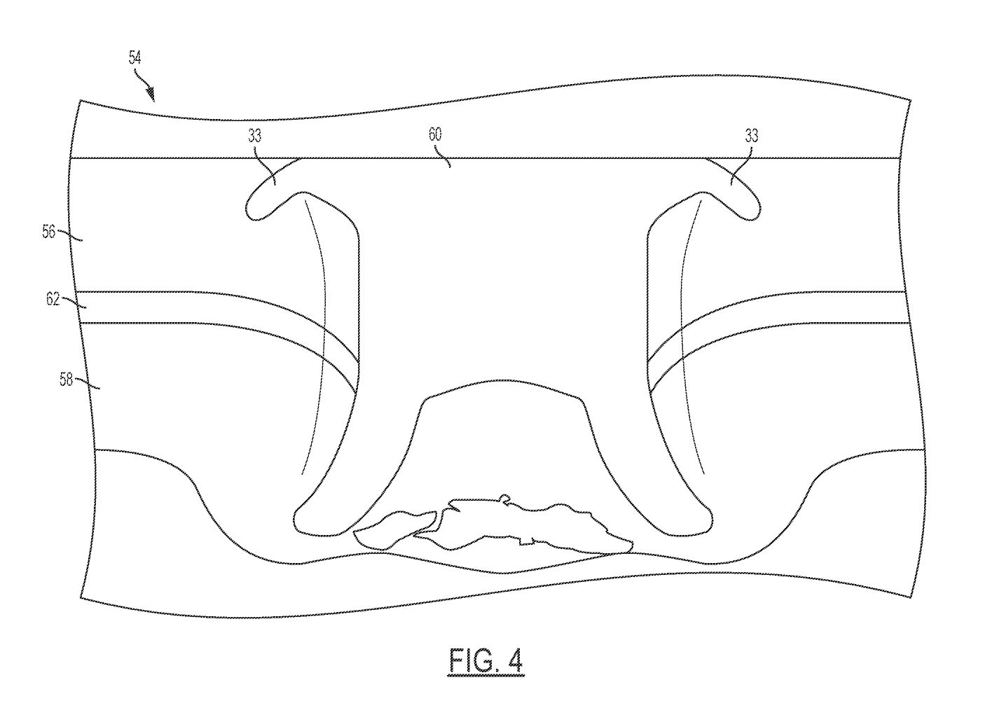

Referring now to FIGS. 2A, 2B, and 2C, an example self-piercing riveting process for joining multiple layers of material with adhesive is illustrated. In this process, a layer 48 of adhesive is applied to at least one of the top and bottom layers 10 and 12, and then the top layer 10 is placed onto the bottom layer 12 so that the adhesive layer 48 is disposed between the top and bottom layers 10 and 12.

The adhesive layer 48 has a third thickness 50, which may be a function of the top and bottom thicknesses 44 and 46 of the top and bottom layers 10 and 12 and/or the material strength of the top and bottom layers 10 and 12. In one example, the third thickness 50 may be between 3 percent and 30 percent of the sum of the top and bottom thicknesses 44 and 46. Thus, if the top and bottom thicknesses 44 and 46 are each 2.5 mm, the third thickness 50 may be between 0.15 mm and 1.5 mm.

After the adhesive layer 48 is applied between the top and bottom layers 10 and 12, the adhesive layer 48 is allowed to fully cure, or at least partially cure. In one example, allowing the adhesive layer 48 to fully cure includes exposing the adhesive layer 48 to room temperature for a first predetermined period (e.g., 60 minutes to 90 minutes). In another example, allowing the adhesive layer 48 to fully cure includes heating the adhesive layer 48 to a predetermined temperature (e.g., approximately 100 degrees Celsius (° C.)) for a bottom predetermined period (e.g., 10 minutes). In another example, allowing the adhesive layer 48 to at least partially cure includes exposing the adhesive layer 48 to room temperature for at least a first predetermined percentage (e.g., 10 percent (%), 20%, 30%, 40%, 50%, 60%, 70%, 80%, 90%, or 100%) of the first predetermined period. In another example, allowing the adhesive layer 48 to at least partially cure includes heating the adhesive layer 48 to the predetermined temperature for at least a second predetermined percentage (e.g., 10%, 20%, 30%, 40%, 50%, 60%, 70%, 80%, 90%, or 100%) of the second predetermined period.

Once the adhesive layer 48 is fully cured, or at least partially cured, the top and bottom layers 10 and 12 and the adhesive layer 48 are positioned on the die 14 as shown in FIG. 2A. The remainder of the process is similar to the process described with reference to FIGS. 1B, 1C, and 1D. However, in contrast to the process of FIGS. 1B, 1C, and 1D, the rivet 26 is inserted into the adhesive layer 48 as well as the top and bottom layers 10 and 12.

Once the top and bottom layers 10 and 12 are positioned on the die 14, the rivet insertion tool 16 is moved in the downward direction 17 until the tube 20 of the rivet insertion tool 16 contacts the top layer 10 as shown in FIG. 2A. In this position, the top and bottom layers 10 and 12 are clamped between the tube 20 of the rivet insertion tool 16 and the die 14. The piston 24 of the rivet insertion tool 16 is then actuated to move the rivet 26 in the downward direction 17 toward the bottom surface 32 of the die 14.

As the piston 24 moves the rivet 26 in the downward direction 17, the tail 30 of the rivet 26 pierces the top layer 10 as shown in FIG. 2B. As the piston 24 continues to move the rivet 26 in the downward direction 17, the rimmed edge 33 of the head 28 pierces and deforms the top layer, and the tail 30 of the rivet 26 pierces and deforms the bottom layer 12 as shown in FIG. 2C. As the rimmed edge 33 deforms the top layer 10, the force induced during the insertion process bens the rimmed edge 33 radially outward and upward. As the tail 30 deforms the bottom layer 12, the protrusion 34 on the bottom surface 32 of the die 14 bends the tail 30 radially outward and in the upward direction 35 toward the top layer 10. The piston 24 may be moved in the downward direction 17 until the piston 24 has moved by at least a predetermined distance and/or until the force applied by the piston 24 on the rivet 26 is greater than or equal to a predetermined force.

When the piston 24 stops moving in the downward direction 17, the head 28 and the rimmed edge 33 of the rivet 26 are fully seated in the top layer 10 with the rimmed edge 33 bent radially outward and upward, and the tail 30 is bent radially outward and upward so as to form a mechanical interlock. As a result, the top and bottom layers 10 and 12 are clamped between the head 28 of the rivet 26 and the tail 30 of the rivet 26 such that the top and bottom layers 10 and 12 are joined together by the rivet 26. The rivet insertion tool 16 is then moved in the upward direction 35, leaving the rivet 26 in place in the top and bottom layers 10 and 12 and the adhesive layer 48.

The tail 30 may be inserted only partially into the bottom layer 12, or the tail 30 may be inserted completely through the bottom layer 12. In addition, the tail 30 may be bent upward toward the top layer 10 by varying degrees. For example, the tail 30 may be bent only slightly upward as shown in FIG. 2C, or the tail 30 may be bent upward by a greater degree so that the distal end of the tail 30 points toward the top layer 10.

Several parameters related to the design of the rivet 26 and the die 14 may be optimized to ensure that the tail 30 pierces the bottom layer 12 and the tail 30 is bent upward toward the top layer 10 after piercing the top and bottom layers 10 and 12. These design parameters may include the length 36 of the rivet 26, the height 38 of the protrusion 34, other geometric aspects of the protrusion 34, the depth 40 of the cavity 18 in the die 14, the diameter 42 of the cavity 18, the volume of the cavity 18, and/or a relationship between two or more of the aforementioned parameters. In addition, one or more of these design parameters may be determined based on the first thickness 44 of the top layer 10, the second thickness 46 of the bottom layer 12, the type(s) of material included in the top and bottom layers 10 and 12, and/or the strength of the material(s) included in the top and bottom layers 10 and 12.

In one example, the length 36 of the rivet 26 may be at least 40 percent greater than a sum of the first and second thicknesses 44 and 46. Thus, if the first and second thicknesses 44 and 46 are each 2.5 mm, the length 36 of the rivet 26 may be at least 7 mm. In other examples, the height 38 of the protrusion 34 may be in a range from 0 mm to 2 mm, and the depth 40 of the cavity 18 may be in a range from 0.5 mm to 2 mm.

The self-piercing riveting processes described above may be used to join multiple layers of CRFTP material, to join multiple layers of another type of material, or to join multiple layers of dissimilar materials. In one example, each of the top and bottom layers 10 and 12 includes or consists of a polymeric composite such as CRFTP. In another example, one of the top and bottom layers 10 and 12 includes or consists of a polymeric composite such as CRFTP, and the other one of the top and bottom layers includes a metal such as stainless steel. In yet another example, each of the top and bottom layers 10 and 12 includes or consists of a metal such as stainless steel.

An example of a riveted joint 52 without adhesive is shown in FIG. 3, and an example of a riveted joint 54 with adhesive is shown in FIG. 4. The riveted joint 52 was formed using the self-piercing riveting process described with reference to FIGS. 1B, 1C, and 1 D. The riveted joint 54 was formed using the self-piercing riveting process described with reference to FIGS. 2A, 2B, and 2C. In both of the riveted joints 52 and 54, top and bottom layers 56 and 58 of CRFTP material are joined together by a self-piercing rivet 60 made of stainless steel. However, only the riveted joint 54 includes a layer 62 of adhesive applied between the top and bottom layers 56 and 58 and allowed to cure before the rivet 60 was inserted into the layers 56 and 58. Testing of the riveted joints 52 and 54 revealed that the peel strength of the riveted joint 52 was actually less than the peel strength of the riveted joint 54. Thus, applying the adhesive between the top and bottom layers 56 and 58 not only reduces the number of rivet and die designs required for a vehicle application, but it also increases the peel strength of the riveted joint.

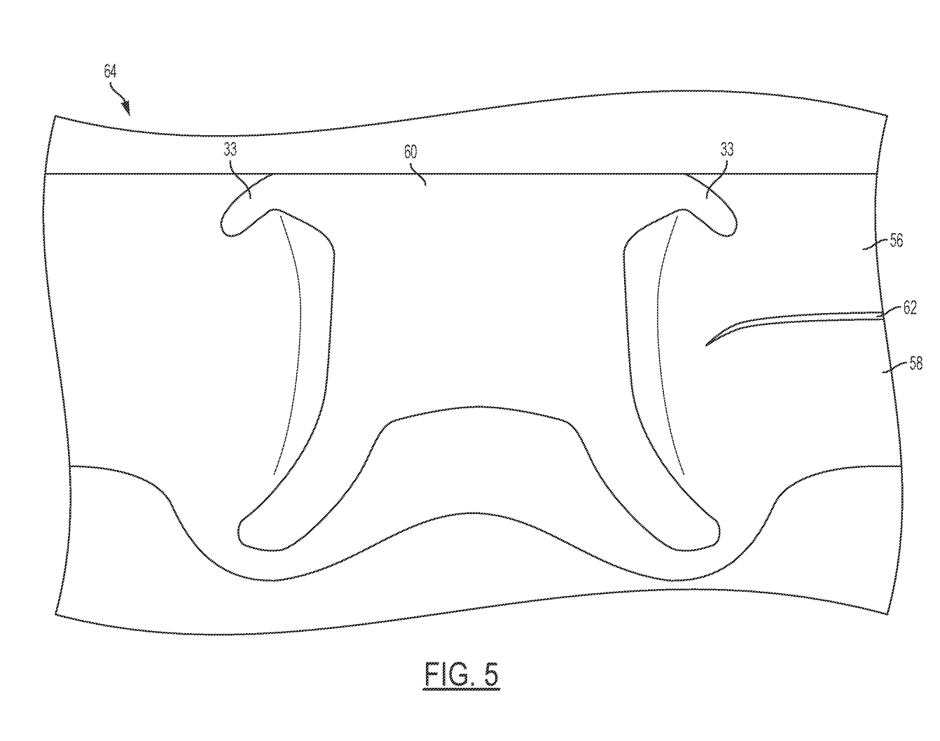

FIG. 5 shows a riveted joint 64 with adhesive that was formed using a process similar to the self-piercing riveting process described with reference to FIGS. 2A, 2B, and 2C. However, instead of applying the adhesive layer 62 between the top and bottom layers 56 and 58 and allowing the adhesive to cure before inserting the rivet 60 into the layers 56 and 58, the rivet 60 was inserted into the layers 56 and 58 before the adhesive was cured. Testing of this riveted joint revealed that its peel strength was less than the peel strength of the riveted joint 54. The reason for this difference in peel strength is that adhesive is squeezed out of the uncured joint of FIG. 5 as the rivet 60 is inserted into the layers 56 and 58. Therefore, only a small amount of adhesive is left between the layers 56 and 58 to hold the layers 56 and 58 together. Thus, allowing the adhesive to fully cure, or at least partially cure, before inserting the rivet 60 into the layers 62 and 64 improves the peel strength of the riveted joint.

In addition, like the riveted joint 52 without adhesive, the stacking order of the layers 56 and 58 in the riveted joint 64 affects the behavior of the rivet 60 as the rivet 60 is inserted into the layers 56 and 58. Thus, like the riveted joint 52, exhaustive trial-and-error testing may be required to find the optimum process parameters for the riveted joint 64, such as rivet and die designs, which yield maximum joint strength. Therefore, allowing the adhesive to fully cure, or at least partially cure, before inserting the rivet 60 into the layers 56 and 58 avoids this additional work and associated costs.

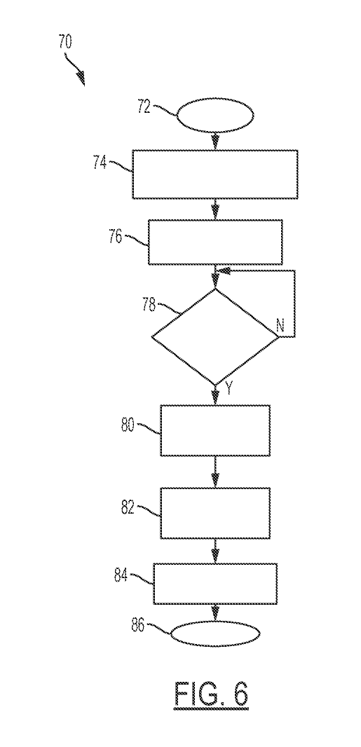

Referring now to FIG. 6, an example method 70 for joining top and bottom layers of material begins at 72. At 74, a rivet is provided having a head 28 and a headless end 30, wherein a rimmed edge 33 extends down from the head 28 toward the headless end 30. At 76, an adhesive layer 48 is applied between the top and bottom layers 10 and 12. At 78, the adhesive layer 48 is allowed to fully cure or at least partially cure. In one example, allowing the adhesive layer 48 to fully cure includes exposing the adhesive layer 48 to room temperature for a first predetermined period (e.g., 60 minutes to 90 minutes). In another example, allowing the adhesive layer 48 to fully cure includes heating the adhesive layer 48 to a predetermined temperature (e.g., 100° C.) for a second predetermined period (e.g., 10 minutes). In another example, allowing the adhesive layer 48 to at least partially cure includes exposing the adhesive layer 48 to room temperature for at least a first predetermined percentage (e.g., 10%, 20%, 30%, 40%, 50%, 60%, 70%, 80%, 90%, or 100%) of the first predetermined period. In another example, allowing the adhesive layer 48 to at least partially cure includes heating the adhesive layer 48 to the predetermined temperature for at least a second predetermined percentage (e.g., 10%, 20%, 30%, 40%, 50%, 60%, 70%, 80%, 90%, or 100%) of the second predetermined period.

At 78, the method 70 determines whether the adhesive layer 48 is fully cured or at least partially cured. In one example, the method 70 may determine that the adhesive layer 48 is fully cured when the adhesive layer 48 has been heated to the predetermined temperature for the second predetermined period. If the adhesive layer 48 is fully cured or at least partially cured, the method 70 continues at 80. Otherwise, the method 70 loops at block 78 until the adhesive layer 48 is fully or at least partially cured.

At 80, the top and bottom layers 10 and 12 are positioned on the die 14. At 82, the rivet 26 is inserted through the top layer 10 and at least partially into the bottom layer 12. At 84, the rimmed edge 33 of the head 28 pierces and deforms the top layer, and the tail 30 of the rivet 26 pierces and deforms the bottom layer 12. As the rimmed edge 33 deforms the top layer 10, the force induced during the insertion process bends the rimmed edge 33 radially outward and upward. As the tail 30 deforms the bottom layer 12, the protrusion 34 on the bottom surface 32 of the die 14 bends the tail 30 radially outward and in the upward direction 35 toward the top layer 10. The method 70 ends at 86.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between top and bottom elements is described in the above disclosure, that relationship can be a direct relationship where no other intervening elements are present between the top and bottom elements, but can also be an indirect relationship where one or more intervening elements are present (either spatially or functionally) between the top and bottom elements. As used herein, the phrase at least one of A, B, and C should be construed to mean a logical (A OR B OR C), using a non-exclusive logical OR, and should not be construed to mean “at least one of A, at least one of B, and at least one of C.”

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. A method of joining at least two layers of material, the method comprising:
providing a rivet having a head and a headless end, wherein a rimmed edge extends downward from the head toward the headless end;
piercing through a top layer with the headless end of the rivet;
deforming the top layer with the rimmed edge and a bottom layer with the headless end of the rivet; and
forcing the rimmed edge and the headless end of the rivet to bend radially outward during deformation of the top and bottom layers to form mechanical interlocks with the top and bottom layers.

2. The method of claim 1 wherein the rivet is a self-piercing rivet.

3. The method of claim 1 further comprising piercing the bottom layer with the headless end of the rivet.

4. The method of claim 1 further comprising applying a layer of adhesive between the top and bottom layers.

5. The method of claim 4 further comprising allowing the adhesive layer to at least partially cure.

6. The method of claim 5 further comprising piercing through the top layer after the adhesive layer is at least partially cured.

7. The method of claim 6 further comprising positioning the top and bottom layers on a die after applying the adhesive layer between the top and bottom layers and before piercing the top layer with the headless end of a rivet.

8. The method of claim 7 further comprising bending the rimmed edge radially outward due to force induced during the riveting process, and bending the headless end of the rivet radially outward using a protrusion formed on a bottom surface of the die.

9. The method of claim 8 further comprising:
clamping the top and bottom layers between a tube and the die;
holding the rivet using a piston disposed within the tube; and
moving the piston toward the bottom surface of the die to force the headless end of the rivet through the top layer and at least partially into the bottom layer.

10. The method of claim 1 wherein the top and bottom layers each include a polymeric composite.

11. The method of claim 1 wherein one of the top and bottom layers includes a polymeric composite and the other one of the top and bottom layers includes a metal.

12. A method of joining at least two layers of material, the method comprising:
providing a rivet having a head and a headless end, wherein a rimmed edge extends downward from the head toward the headless end;
applying a layer of adhesive between a top and a bottom layer;
piercing the top layer with a headless end of a rivet;
deforming the top layer with the rimmed edge and the bottom layer with the headless end of the rivet; and
forcing the rimmed edge and the headless end of the rivet to bend radially outward during deformation of the top and bottom layers to form mechanical interlocks with the top and bottom layers.

13. The method of claim 12 wherein the rivet is a self-piercing rivet.

14. The method of claim 12 further comprising positioning the top and bottom layers on a die after applying the adhesive layer between the top and bottom layers and before piercing the top layer with the headless end of a rivet.

15. The method of claim 14 further comprising rimmed edge radially outward due to force induced during the riveting process, and bending the headless end of the rivet radially outward using a protrusion formed on a bottom surface of the die.

16. The method of claim 15 further comprising:
clamping the top and bottom layers between a tube and the die;
holding the rivet using a piston disposed within the tube; and
moving the piston toward the bottom surface of the die to force the headless end of the rivet through the top layer and at least partially into the bottom layer.

17. The method of claim 12 wherein the top and bottom layers each include a polymeric composite.

18. The method of claim 12 wherein one of the top and bottom layers includes a polymeric composite and the other one of the top and bottom layers includes a metal.

19. The method of claim 12 further comprising piercing the bottom layer with the headless end of the rivet.

20. The method of claim 12 further comprising allowing the adhesive layer to at least partially cure before piercing the top layer with the headless end of the rivet and deforming the bottom layer with the headless end of the rivet.
